(19) United States
(12) Patent Application Publication
(10) Pub. No.: US 2024/0338135 A1
(43) Pub. Date: Oct. 10, 2024

(54) STORAGE SPACE ALLOCATION METHOD, TERMINAL DEVICE AND STORAGE MEDIUM

(71) Applicant: SHENZHEN ZOLON TECHNOLOGY CO., LTD., Shenzhen (CN)

(72) Inventor: JIAN WANG, Shenzhen (CN)

(21) Appl. No.: 18/747,439

(22) Filed: Jun. 19, 2024

Related U.S. Application Data
(63) Continuation-in-part of application No. PCT/CN2022/125973, filed on Oct. 18, 2022.

(30) Foreign Application Priority Data
Dec. 31, 2021 (CN) 202111675882.8

(51) Int. Cl. G06F 3/06

(52) U.S. Cl. CPC G06F 3/0631; G06F 3/0604; G06F 3/064; G06F 3/0673

(57) ABSTRACT

The present application provides a storage space allocation method. The method includes allocating a first virtual address block list based on an initial storage space requirement of each table object in a database. A first correlation and a second correlation are obtained. Based on the first correlation and the second correlation, a first virtual address and a first physical address which correspond to first data in the table object and a second physical address and a second virtual address of second data are obtained after performing an addition/deletion operation on the first data. Once a storage status of the second physical address and a storage status of a second physical block are updated, a storage status of the second virtual address and a storage status of a second virtual block are synchronously updated.

The present application claims a priority of a Chinese patent application with an application number 202111675882.8 filed with the China National Intellectual Property Administration on Dec. 31, 2021, the entire contents of which are incorporated by reference in the present application.

### FIELD

The present application belongs to a field of computer technology, and more particularly to a storage space allocation method, a terminal device and a storage medium.

### BACKGROUND

At present, in a running process of an application program, an allocation and a release of an internal memory can be continuously carried out. In the prior art, a memory allocator (such as malloc memory allocator) is generally adopted to carry out a memory allocation, the memory allocator implements a paging management, a virtual address space of a process is divided into several pages with a predetermined size, and are numbered (can be numbered based on an address of a logical address space); correspondingly, a physical memory of a computer is also divided into blocks of a same size, and are numbered (can be numbered based on the address of the physical address space); a size of a paging is generally a fixed space, for example, 4 KB.

There is also a prior art that specifies a number and a size of large pages of a physical memory, and then divides the large page into memory blocks of smaller fixed space to generate a memory pool, and manages free memory blocks in the memory pool.

The above prior art can only carry out the memory allocation of a fixed space for a process, and a part of the free memory that is smaller than the fixed space cannot be effectively used, which is not conducive to improving a utilization rate of a storage resource of the computer and a performance of the computer. In addition, a traditional method of the memory allocation also produces a large amount of memory fragments, resulting in a reduction in an use efficiency of a memory and a reduction in the performance of the computer.

### BRIEF DESCRIPTION OF THE DRAWINGS

In order to more clearly illustrate technical solutions in the embodiments of the present application, drawings required for use in the embodiments or in the description of the prior art are briefly introduced below. Obviously, the drawings described below are only some embodiments of the present application. For an ordinary skilled in the art, other drawings can be obtained based on these drawings without paying a creative work.

FIG. 1 is a schematic diagram of a flow chart of a storage space allocation method of a database provided in one embodiment of the present application;

FIG. 2 is a schematic diagram of mapping physical blocks and virtual blocks when a shared storage space is expanded according to an embodiment of the present application;

FIG. 3 is a schematic diagram of a flow chart of adding new data in step S140 according to an embodiment of the present application;

FIG. 4 is a schematic diagram of a flow chart of deleting data in step S140 according to an embodiment of the present application;

FIG. 5 is a schematic diagram of a structural framework of a storage space allocation device of a database provided in another embodiment of the present application.

FIG. 6 is a structural diagram of a terminal device provided by an embodiment of the present application.

### DETAILED DESCRIPTION

In the following description, in order to illustrate rather than to limit, specific details such as a specific system structure, a technology and the like are proposed, so as to thoroughly understand the embodiments of the present application. However, it should be clear to those skilled in the art that in other embodiments without these specific details, the present application can also be realized. In other cases, detailed descriptions of a well-known system, a device, a circuit and a method are omitted to avoid unnecessary details hindering the description of the present application.

It should be understood that when used in the present specification and the appended claims, a term “comprising” indicates a presence of described features, wholes, steps, operations, elements and/or components, but does not exclude a presence or an addition of one or more other features, wholes, steps, operations, elements, components and/or collections thereof.

It should also be understood that a term “and/or” used in the present specification and the appended claims refers to any combination and all possible combinations of one or more of associated listed items, and includes these combinations.

In addition, in the descriptions of the specification of the present application and the appended claims, terms “first”, “second”, “third”, etc. are only used to distinguish the descriptions and cannot be understood as indicating or implying relative importance.

In the description of the present application, reference to “one embodiment” or “some embodiments” or the like means that a particular feature, a structure or a characteristic described in connection with the embodiment is included in one or more embodiments of the present application. Thus, statements “in one embodiment”, “in some embodiments”, “in some other embodiments”, “in some other embodiments” etc. that appear in this specification are not necessarily all with reference to the same embodiment, but mean “one or more but not all embodiments”, unless otherwise particularly emphasized.

Terms “comprises”, “includes”, “has” and their deformation all mean “including but not limited to”, unless otherwise particularly emphasized.

The technical solution of the present application is described below by means of specific embodiments.

### Embodiment 1

In the prior art, a storage space required by a table object in any database changes continuously as data is written and deleted, and an allocation process of the storage space provided by an operating system cannot adapt to such dynamic changes. A virtual storage management solution is needed to solve the above problem.

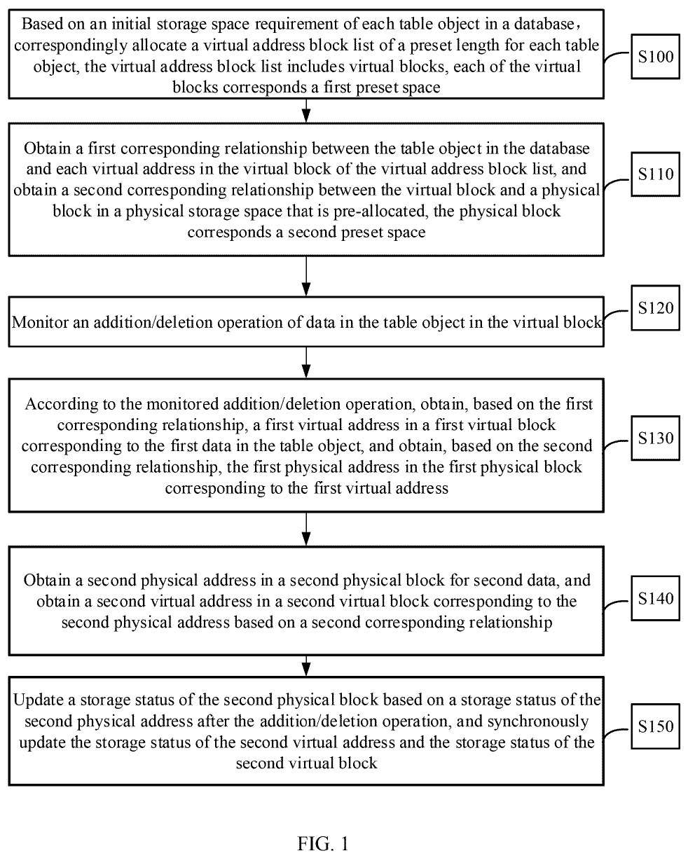

As shown in FIG. 1, an embodiment of the present application provides a storage space allocation method for a shared storage space database, including following steps:
S100, based on an initial storage space requirement of each table object in a database, a first virtual address block list of a preset length is correspondingly allocated for each table object, the first virtual address block list includes virtual blocks, each of the virtual blocks corresponds a first preset space;
S110, a first corresponding relationship between the table object in the database and each virtual address in the virtual block of the first virtual address block list is obtained, and a second corresponding relationship between the virtual block and a physical block in a physical storage space that is pre-allocated is obtained, the physical block is corresponding to a second preset space;
S120, an addition/deletion operation of data in the table object in the virtual block is monitored;
S130, according to the monitored addition/deletion operation, a first virtual address in the first virtual block corresponding to first data in the table object is obtained based on the first corresponding relationship, and a first physical address in the first physical block corresponding to the first virtual address is obtained based on the second corresponding relationship;
S140, a second physical address in a second physical block is obtained for second data, and a second virtual address in a second virtual block corresponding to the second physical address is obtained based on a second corresponding relationship; the second data is obtained by performing the addition/deletion operation on first data.
S150, based on a storage status of the second physical address after the addition/deletion operation, a storage status of the second physical block is updated, and a storage status of the second virtual address and a storage status of the second virtual block are synchronously updated.

The present embodiment provides a corresponding virtual address space block list for each table object in the shared storage space database, and dynamically manages an expansion and a release of the shared storage space of each table object, thereby realizing a storage space virtualization management, thereby improving a use efficiency of the shared storage space. The present embodiment not only allocates the shared storage space according to a storage space with a fixed size of each table object, but also allocates the dynamic storage space according to a storage space with the fixed size of each table object. In addition, the present embodiment can also perform a storage space recovery processing when each table object releases the storage space, and when recovering the storage space, it can be merged with the adjacent free storage space blocks to reduce a fragmentation of the shared storage space, thereby improving a performance of the computer and the use efficiency of the shared storage space.

In this embodiment, the storage space is not limited to a physical memory space and a shared physical memory space, but also includes various external storage spaces such as a disk, an optical disk, a USB, and a mobile hard disk.

The technical solution of this embodiment is specifically described step by step below.

A method for allocating a storage space of a shared storage space database includes the following steps:

S100, based on an initial storage space requirement of each table object in a database, a first virtual address block list of a preset length is correspondingly allocated for each table object, the first virtual address block list includes virtual blocks, each of the virtual blocks corresponds a first preset space.

In this embodiment, when the database is initialized in a shared storage space, a database system correspondingly allocates the first virtual address block list of the preset length according to the initial storage space requirement of each table object in the database, the first virtual address block list includes virtual blocks, each of the virtual blocks corresponds a first preset space. Preferably, the first virtual address block list includes at least one virtual block which is corresponding to the first preset space, and the virtual block is a virtual address block.

Specifically, in the present embodiment, “system” or “database system” refers to a management system of the database of the present embodiment, which is responsible for an operation management of the whole database and refers to a system of a database server. The database system is established in an environment of a Linux operating system.

Further, in this embodiment, the preset length is set to be less than or equal to 2147483648. For example, the database system allocates a virtual address space to each table object in the database. There are 2147483648 sequences in the virtual address space, and the sequences start from 0 to 2147483647. These sequences constitute the virtual address block list, each virtual address block includes a specified number of consecutively numbered sequences, and each virtual block in the virtual address block list is numbered consecutively in sequence starting from 0. The specified number is preferably set to 100 sequences to generate a virtual address block, so that each virtual block can store 100 records. A length of data that can be stored in each sequence is determined according to a length of a row of the data defined by a structure of the table object. The database system initially allocates at least one virtual block to each table object to generate the first virtual address block list, preferably, initially allocates one virtual block to each table object. Among them, each virtual block presets a space size when it is initialized, and the first preset space is set to be less than or equal to 4 MB, preferably, the first preset space is set to 4 MB.

A number of sequences of the virtual address space greater than 200 million is set to be an upper limit can cover needs of table objects in most industries, and avoid a situation that the number of sequences is set too small, resulting in the table objects in some industries not being able to be met. the first preset space of each virtual block is preferably set to 4 MB can also meet the needs of table objects in most industries, and avoid the situation where the table objects in some industries cannot be fully written into one virtual block due to the setting being too small, and avoid a situation where the space is wasted due to the setting being too large, so that the virtual address space is effectively utilized.

S110, a first corresponding relationship between the table object in the database and each virtual address in the virtual block of the first virtual address block list is obtained, and a second corresponding relationship between the virtual block and a physical block in a physical storage space that is pre-allocated is obtained, the physical block is corresponding to a second preset space;

Specifically, in this embodiment, a corresponding relationship is set between the table object in the database and each virtual address in the virtual block of the first virtual address block list, thereby obtaining the first corresponding relationship, and a corresponding relationship is set between the virtual block and the physical block in the physical storage space, thereby obtaining the second corresponding relationship. The physical storage space is divided into a plurality of physical blocks, and the second preset space is set for each physical block, the second preset space is set to be less than or equal to 4 MB, and preferably, the second preset space is set to 4 MB.

According to the content in S110, for example, if a table object has 150 records, there are two virtual blocks in total, a first virtual block is numbered “0”, and a second virtual block is numbered “1”, the first virtual block stores virtual addresses of the 1st to 100th records, and the second virtual block stores virtual addresses of the 101st to 150th records, and the virtual addresses corresponding to the 1st to 150th records are 0 to 149, the above is a first pre-setting. According to the first pre-setting, each record in each table object has its own corresponding virtual address in the virtual block of the first virtual address block list, and the corresponding virtual block and the specified virtual address in the virtual block can be accurately found through a sequence number of the virtual address corresponding to each record of the table object, the above is the first corresponding relationship. For example, it can be calculated through an address mapping that a record with a virtual address sequence 123 is stored in a virtual space with a virtual block number “1” and an intra-block address offset 23 in the table object.

Further, in this embodiment, the first preset space is set to be equal to the second preset space, both are set to 4 MB, and each physical block is also set to 100 physical addresses. Each physical block that has been allocated and used by the table object is matched to each virtual block corresponding to the table object in a first-to-last allocation order, among them, when the database system provides a data storage function to the table object, a virtual continuous address space is provided, so a number of each virtual block of the table object is also a continuous number, and a number of each physical block that has been allocated and used by the table object can be a continuous number or a discontinuous number, and is allocated according to whether a storage status of the physical block is idle, the above is a second preset. According to the second preset, a starting address of each first-numbered physical block is mapped to a starting address of a corresponding second-numbered virtual block, that is, the physical address in each physical block from the beginning to the end is matched to the address in the corresponding virtual block from the beginning to the end, the above is the second corresponding relationship.

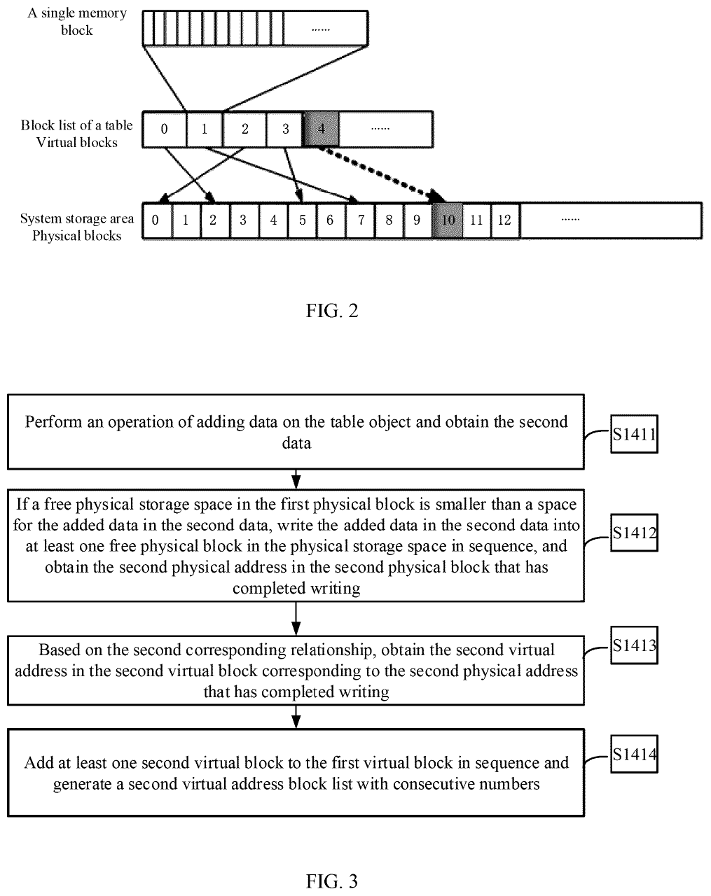

As shown in FIG. 2, for example, there are four virtual blocks numbered consecutively from 0 to 3 in the virtual address block list of the table object, among them, a virtual block numbered “0” corresponds to a physical block numbered “2”, a virtual block numbered “1” corresponds to a physical block numbered “7”, a virtual block numbered “2” corresponds to a physical block numbered “0”, and a virtual block numbered “3” corresponds to a physical block numbered “5”, and the numbers of these four physical blocks are discontinuous. For example, it can be calculated through the address mapping that the record with the virtual address sequence 123 is stored in the virtual address with the virtual block number “1” and the intra-block address offset 23 in the table object. Based on the second pre-setting and the second corresponding relationship, the virtual block number is mapped to the physical block number, and the virtual block with the virtual block number “1” in the table object is mapped to the physical block with the physical block number “7” in the shared physical storage space. Therefore, an actual physical address of the record with the virtual address sequence 123 is 7×100+23=723, and corresponding content of the record can be read from the physical address 723.

A specific calculation process of the address mapping is:

First, a virtual block number where the record is located is calculated;

For example, int iBlockNo=123/100=1 is adopted; //obtaining a virtual block number by using a virtual block number of 1.

Then an address offset within a block where the record is located is calculated;

For example, int iBitNo=123% 100=23 is adopted; //obtaining an address offset within the block by using an intra-block offset of 23.

An actual physical address location of the record is obtained according to the second preset and the second corresponding relationship;

For example, based on the second preset and the second corresponding relationship, the actual physical address is obtained as an address of 723.

S120, an addition/deletion operation of data in the table object in the virtual block is monitored;

Specifically, the database system detects an operation of adding data or an operation of deleting data in the physical block of each data record in the table object, so as to allocate or release the storage space at any time according to a result of the addition operation or the deletion operation, so as to improve a use efficiency of the shared storage space and enhance a performance of the computer. In this embodiment, since an operation of querying a data record does not cause a change of the storage space of the table object, no detection is performed to save the resources of the computer.

S130, according to the monitored addition/deletion operation, a first virtual address in a first virtual block corresponding to first data in the table object is obtained based on the first corresponding relationship, and a first physical address in a first physical block corresponding to the first virtual address is obtained based on the second corresponding relationship;

Specifically, in the present embodiment, according to the detected addition/deletion operation, based on the first corresponding relationship, the first virtual address in the first virtual block corresponding to the first data in the table object at a beginning of the addition/deletion operation can be obtained. That is, the operation of add/delete the data record in the table object has just begun, and based on the first corresponding relationship, the virtual block number and the virtual address within the block corresponding to the data record before the addition/deletion operation can be obtained. For example, if the addition/deletion operation is to be performed on the data record with the virtual address sequence of 390, then based on the first corresponding relationship, the virtual block number of the data record with the virtual address sequence of 390 is obtained as “3”, and the intra-block address offset is 90, then the first data is the data record with the virtual address sequence of 390, the first virtual block is the virtual block numbered “3”, and the first virtual address refers to an address offset within the virtual block numbered “3” is 90.

Specifically, in this embodiment, based on the second corresponding relationship, the first physical address in the first physical block corresponding to the first virtual address of the first data is obtained. For example, the first virtual address refers to the address offset within the virtual block numbered “3” is 90, the corresponding first physical block is the physical block numbered “5”, and the first physical address in the first physical block refers to an address offset within the physical block numbered “5” is 90.

S140, a second physical address in a second physical block is obtained for second data, and a second virtual address in a second virtual block corresponding to the second physical address is obtained based on the second corresponding relationship; the second data is obtained by performing the addition/deletion operation on first data.

Specifically, in the present embodiment, the second data is generated by performing the addition/deletion operation on the first data. Since the addition/deletion operation is performed on the physical block, the second physical address in the second physical block can be obtained based on the second data after the addition/deletion operation, and based on the second corresponding relationship, the second virtual address in the second virtual block corresponding to the second physical address can also be obtained. In the present embodiment, the addition/deletion operation includes an operation of adding data or an operation of deleting data, and both operations can cause the shared storage space of the first data to change. A size of the shared storage space of the second data after the addition/deletion operation is different from a size of the shared storage space of the first data. Therefore, the second physical address in the second physical block of the second data after the addition/deletion operation, and the corresponding second virtual address in the second virtual block are changed compared with the physical address and the virtual address of the original first data.

Specifically, in this embodiment, the step of obtaining the second physical address in the second physical block for the second data after the addition/deletion operation, and obtaining the second virtual address in the second virtual block corresponding to the second physical address based on the second corresponding relationship includes the following steps:
S1411, an operation of adding data is performed on the table object to obtain second data;
S1412, if a free physical storage space in the first physical block is smaller than a space for the added data in the second data, the added data in the second data is written into at least one free physical block in the physical storage space in sequence, and a second physical address in the second physical block that has completed writing is obtained;
S1413, based on the second corresponding relationship, the second virtual address in the second virtual block corresponding to the second physical address that has completed writing is obtained;
S1414, at least one second virtual block is added to the first virtual block in sequence to generate a second virtual address block list with consecutive numbers.

Specifically, as shown in FIG. 3, in this embodiment, firstly, an operation of adding new data is performed on the table object to obtain a new data record in the table object to generate the second data, and the operation of adding new data includes inserting new data and modifying and adding new data. The operation of adding new data to the first data in the original table object causes the shared storage space of the first data in the table object to increase, and the shared storage space of the first data needs to be expanded.

Secondly, the free physical storage space in the first physical block where the first data is located is determined. If the free physical storage space of the first physical block is smaller than the space of the added data in the second data, the added data in the second data is sequentially written into the first free physical block in the physical storage space to obtain the second physical address in the second physical block, thereby realizing an expansion of the physical storage space of the second data. If the added data in the second data is too large and exceeds the space of an idle physical block, after the added data in the second data fills up a first free physical block in the physical storage space to obtain the second physical address in the second physical block, a first free physical block in an idle physical block queue is continuously searched in the physical storage space, and the unwritten newly added data is continuously written into a new free physical blocks in sequence, until all the added data in the second data is written into the free physical blocks, and the second physical block and the second physical address within the block are updated to a last free physical block and the physical address within the block, thereby obtaining the latest second physical block and the second physical address within the block of the second data.

Then, based on the second corresponding relationship, the added data in the second data obtains the second virtual address in the second virtual block corresponding to the second physical address. In this way, the second physical address of the added data in the second data after the physical storage space is expanded can obtain the new second virtual block in the virtual address space and the second virtual address within the block through the second corresponding relationship, thereby realizing the expansion of the second data in the virtual address space.

If there are more than one free physical blocks into which the added data in the second data is written, the free physical blocks and the physical addresses within the blocks after the added data in the second data is completely written are used as the second physical addresses in the second physical blocks. In a process of continuously writing the new data in the second data into the free physical blocks, based on the second corresponding relationship, new second virtual blocks and second virtual addresses within the blocks are continuously obtained in the virtual address space, thereby realizing continuous expansion of the second data in the virtual address space.

Finally, at least one second virtual block is sequentially added to the first virtual block to generate a second virtual address block list with consecutive numbers. After the second data virtual address space is expanded, a new second virtual block and a second virtual address within the block are generated. In order to maintain the continuity of the data in the table object, the second virtual block is added to the first virtual block corresponding to the first data in the first virtual address block list, and the block number of the second virtual block is increased by 1 based on the block number of the first virtual block, thereby generating the second virtual address block list with consecutive numbers.

If there are more than one free physical blocks for writing the added data in the second data, there are also more than one second virtual block during the writing process, and new second virtual blocks and second virtual addresses within the blocks may be continuously obtained in the virtual address space. The continuously generated new second virtual blocks are added to the first virtual blocks in turn to generate a list of second virtual address blocks with consecutive numbers, thereby maintaining the continuity of the data in the table object in the virtual address space.

For example, the first data is a data record with a virtual address sequence of 390, the first virtual block number is “3”, the virtual address offset within the block is 90, the first physical block number is “5”, the virtual address offset within the block is 90, and there are 9 free physical addresses. Since a physical block is set to 4 MB, a remaining free storage space is approximately 0.4 MB. Now, an operation of adding new data is performed on the first data to obtain the second data.

If a space for the added data is greater than 0.4 MB but less than 4 MB, the free physical storage space in the physical block “5” is smaller than the space for the added data in the second data, and if the first 10 physical blocks in the system storage area have been allocated, and the first free physical block in the system storage area has a block number “10”, then after the added data in the second data fills up the physical block “5”, it will continue to be written into the physical block “10” in sequence, thereby the second physical block “10” that has completed writing and the second physical address within the block are obtained.

Based on the second corresponding relationship, the second physical block “10” that has completed writing and the second physical address within the block correspond to the second virtual block and the second virtual address within the block.

The second virtual block is then added to the first virtual block “3”, and according to a rule of consecutive numbering, the number of the second virtual block is changed to “4”, a second virtual address block list of five consecutively numbered virtual blocks is generated.

If the space for the added data is greater than 4 MB, as in the above embodiment, the number of free physical blocks into which the added data is sequentially written is greater than one, and the corresponding number of second virtual blocks is also greater than one, ultimately a second virtual address block list of greater than five consecutively numbered virtual blocks is generated.

Specifically, in an embodiment of the present application, the step of obtaining the second physical address in the second physical block for the second data after the addition/deletion operation, and obtaining the second virtual address in the second virtual block corresponding to the second physical address based on the second corresponding relationship, further includes the following steps:
S1421, an operation of deleting data is performed on the table object to obtain second data;
S1422, if the physical storage space in the first physical block is larger than the space of the second data, at least one occupied physical block in the physical storage space is released in sequence based on the space of the second data after data is deleted, and a second physical address in the second physical block that has completed deleting is obtained;
S1423, based on the second corresponding relationship, a second virtual address in the second virtual block corresponding to the second physical address that has completed deleting is obtained;
S1424, starting from the first virtual block, at least one second virtual block is released in sequence forward to generate a second virtual address list with consecutive numbers.

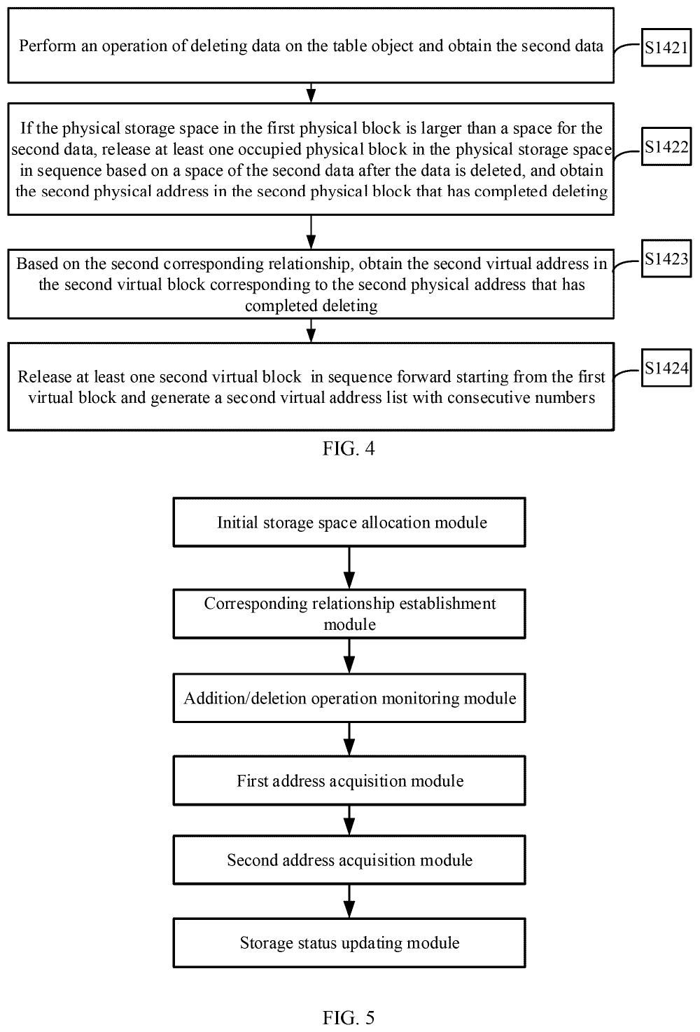

Specifically, as shown in FIG. 4, in this embodiment, firstly, an operation of deleting data is performed on the table object to obtain a new data record in the table object to generate the second data, and the operation of deleting data includes deleting new data. The operation of deleting data on the first data in an original table object results in a reduction in the shared storage space occupied by the first data in the table object, and the free shared storage space of the first data needs to be released.

Secondly, the free physical storage space in the first physical block where the first data is located is determined. If the physical storage space in the first physical block is larger than the space of the second data, the second physical address where the second data is located and the free physical storage space in the second physical block are released, thereby realizing the release of the physical storage space of the second data, reducing the shared storage space occupied by the second data, and the released free storage space is convenient for use by other table objects or other data records, thereby improving the use efficiency of the shared storage space and enhancing the performance of the computer;

If the deleted data is relatively large, larger than the second preset space of one physical block, the released free physical storage space is larger than one physical block, and the released free physical storage space is released in sequence from back to front according to the physical address previously occupied by the second data until all the free physical storage space is released, and the second physical block and the second physical address within the block are updated to a last released free physical block and the physical address within the block, thereby obtaining the latest second physical block and the second physical address within the block of the second data.

Then, based on the second corresponding relationship, the second data after deleting data obtains the second virtual address in the second virtual block corresponding to the second physical address. In this way, the second physical address of the second data after the physical storage space is released obtains the second virtual address in the new second virtual block in the virtual address space through the second correspondence relationship, and release the second virtual address and the free virtual address in the second virtual block, thereby realizing the release of the second data in the virtual address space.

If the deleted data is relatively large, larger than the second preset space of one physical block, the physical block where the second data is located and the physical address within the block that has completed deleting in the operation of deleting data are set to the second physical address in the second physical block. In the process of continuously deleting data, based on the second corresponding relationship, new second virtual blocks and second virtual addresses within the blocks are continuously obtained in the virtual address space, thereby realizing a continuous release of the second data in the virtual address space.

Finally, starting from the first virtual block, at least one second virtual block is released in sequence forward to generate a second virtual address list with consecutive numbers. After the virtual address space of the second data is released, a new second virtual block and a second virtual address within the block are generated. In order to maintain the continuity of data in the table object, starting from the first virtual block corresponding to the first data in the first virtual address block list, the second virtual block is released in sequence forward to generate a second virtual address list with consecutive numbers. At the same time, the block number of the second virtual block is reduced by 1 based on the block number of the first virtual block, thereby generating the second virtual address list with consecutive numbers.

If a number of the occupied physical blocks released by the second data after the data is deleted exceeds one, the second virtual block also exceeds one during a deletion process, and new second virtual blocks and second virtual addresses within the blocks are continuously obtained in the virtual address space. Starting from the first virtual block, the continuously generated new second virtual blocks are released in sequence forward to generate a list of second virtual address blocks with consecutive numbers, thereby maintaining the continuity of the data in the table object in the virtual address space.

The specific implementation process of the above technical solution will not be repeated any more.

S150, based on a storage status of the second physical address after the addition/deletion operation, a storage status of the second physical block is updated, and a storage status of the second virtual address and a storage status of the second virtual block are synchronously updated.

Specifically, in this embodiment, the storage status of the second physical address where the second data is located after the addition/deletion operation is occupied or free, so it is also necessary to update the storage status of the second physical block according to the space of the occupied or free physical storage space, and synchronously update the storage status of the second virtual address and the storage status of the second virtual block.

Further, in this embodiment, the step of based on the storage status of the second physical address after the addition/deletion operation, updating the storage status of the second physical block and synchronously updating the storage status of the second virtual address and the storage status of the second virtual block includes:
S1511, after the operation of adding data is performed on the table object, the storage status of the second physical address is updated from an idle status to an occupied status, and the storage status of the second physical block where the second physical address is located is also updated from the idle status to the occupied status;
S1512, the storage status of the second virtual address corresponding to the second physical address is synchronously updated from the idle status to the occupied status, and the storage status of the second virtual block where the second virtual address is located is also synchronously updated from the idle status to the occupied status.

Specifically, in this embodiment, after the operation of adding data is performed on the table object, the second data has occupied the second physical address and the second physical block where the second physical address is located. Therefore, in the system storage area, the second physical address needs to be updated from the idle status to the occupied status, and the storage status of the second physical block where the second physical address is located needs to be updated from the idle status to the occupied status.

Based on the second corresponding relationship, the storage status of the second virtual address in the virtual address space corresponding to the second physical address is also synchronously updated from the idle status to the occupied status, and the storage status of the second virtual block where the second virtual address is located is also synchronously updated from the idle status to the occupied status.

For example, as shown in FIG. 2, after the physical block “10” is occupied, it is necessary to update the physical block “10” from an original idle status to the occupied status, and the virtual block “4” corresponding to the physical block “10” is also synchronously updated from the original idle status to the occupied status.

If there are more than one occupied physical blocks, the storage status is also updated in sequence.

Further, in this embodiment, the step of based on the storage status of the second physical address after the addition/deletion operation, updating the storage status of the second physical block and synchronously updating the storage status of the second virtual address and the storage status of the second virtual block also includes:
S1521, after the operation of deleting data is performed on the table object, the storage status of the second physical address continues to be set to the occupied status, and the storage status of the second physical block where the second physical address is located continues to be set to the occupied status;
S1522, a storage status of a third physical address is updated from the occupied status to the idle status, and the storage status of the first physical block where the first physical address is located is updated from the occupied status to the idle status, the third physical address is a physical address segment between the first physical address and the second physical address;
S1523, the storage status of the second virtual address corresponding to the second physical address continues to be set to the occupied status, and the storage status of the second virtual block corresponding to the second physical block where the second physical address is located continues to be set to the occupied status;
S1524, a storage status of a third virtual address corresponding to the third physical address is synchronously updated from the occupied status to the idle status, and the storage status of the first virtual block where the first virtual address is located is also synchronously updated from the occupied status to the idle status, and the third virtual address is a virtual address segment between the first virtual address and the second virtual address.

Specifically, in this embodiment, first, after the data is deleted in the table object, the second physical address occupied by the second data continues to be the occupied status, and the second physical block where the second physical address is located also continues to be the occupied status;

Secondly, since the physical storage space occupied by the second data is smaller than the physical storage space of the first physical block, it is necessary to release a redundant idle physical storage space after deleting the data so as to make the use of the shared storage space more efficient. Therefore, the physical address segment between the first physical address and the second physical address that have been released is defined as the third physical address, and the storage status of the third physical address is updated from the original occupied status to the idle status. Since the original first physical address is already idle and the second physical address is no longer in the first physical block, the storage status of the first physical block where the first physical address is located is also updated from the occupied status to the idle status.

In addition, if the space of deleting the data is relatively small, resulting in the second physical address still being in the first physical block, at this time the second physical block is equal to the first physical block. Continuing to set the second physical block to an occupied status causes the first physical block to continue to remain in an occupied status and cannot be released.

Then, due to the second corresponding relationship, the storage status of the second physical address is an occupied status, and the storage status of the corresponding second virtual address also continues to be set to an occupied status. Since the storage status of the second physical block where the second physical address is located is also an occupied status, the storage status of the corresponding second virtual block also continues to be set to an occupied status.

Finally, the virtual address segment between the first virtual address and the second virtual address is set as the third virtual address. Based on the second corresponding relationship, the third physical address corresponds to the third virtual address. Since the storage status of the third physical address is synchronously updated from the occupied status to the idle status, the storage status of the corresponding third virtual address is also synchronously updated from the occupied status to the idle status. At the same time, since the second virtual address is not in the first virtual block, the first virtual address is already in idle status, so the storage status of the first virtual block where the first virtual address is located is also synchronously updated from the occupied status to the idle status.

In addition, if the space of deleting the data is relatively small, resulting in the second virtual address still being in the first virtual block, at this time the second virtual block is equal to the first virtual block. Continuing to set the second virtual block to an occupied status causes the first virtual block to continue to remain in an occupied status and cannot be released.

The specific implementation process of the above technical solution will not be repeated.

In addition, in this embodiment, after the steps of obtaining the first corresponding relationship between the table object in the database and the virtual addresses in the virtual blocks of the virtual address block list, and obtaining the second corresponding relationship between the virtual blocks and the physical blocks in the pre-allocated physical storage space, the following steps are also included:
S1210, addition/deletion operations of data in each of the table objects in the virtual block are concurrently monitored;
S1220, according to the concurrently monitored addition/deletion operations, a first virtual address in a first virtual block corresponding to the first data in each of the table objects is concurrently obtained based on the first corresponding relationship, and a first physical address in a first physical block corresponding to each of the first virtual addresses is concurrently obtain based on the second corresponding relationship;
S1230, a second physical address in a second physical block is concurrently obtained for the second data after the addition/deletion operations, and a second virtual address in a second virtual block corresponding to the second physical address is concurrently obtained based on a second corresponding relationship;
S1240, based on the storage status of the second physical address after the concurrent addition/deletion operations, the storage status of the second physical block is updated, and the storage status of the second virtual address and the storage status of the second virtual block are synchronously updated concurrently.

In this embodiment, the technical solutions of each step are basically the same as the technical solutions of S120, S130, S140, and S150 mentioned above. The difference is that the above S120, S130, S140, and S150 are mainly shared storage space allocation methods for adding and deleting data in a single table object, while the technical solutions of S1210, S1220, S1230, and S1240 are mainly shared storage space allocation methods for concurrently adding and deleting data in a plurality of table objects.

Further, the present embodiment also provides a memory allocation method for a shared memory database, including the following steps:
A first virtual address block list of a preset length is correspondingly allocated based on an initial storage space requirement of each table object in a database, the first virtual address block list includes virtual blocks, each of the virtual blocks corresponds a first preset space;
A first corresponding relationship between the table object in the database and each virtual address in the virtual block of the first virtual address block list is obtained, and a second corresponding relationship between the virtual block and a physical block in a physical storage space that is pre-allocated is obtained, the physical block is corresponding to a second preset space;
An addition/deletion operation of data in the table object in the virtual block is monitored;
According to the monitored addition/deletion operation, a first virtual address in the first virtual block corresponding to first data in the table object is obtained based on the first corresponding relationship, and a first physical address in the first physical block corresponding to first virtual address is obtained based on the second corresponding relationship;
A second physical address in a second physical block is obtained for second data generated after the addition/deletion operation, and a second virtual address in a second virtual block corresponding to the second physical address is obtained based on the second corresponding relationship;
Based on the storage status of the second physical address after the addition/deletion operation, the storage status of the second physical block is updated, and the storage status of the second virtual address and the storage status of the second virtual block are synchronously updated.

Since a space of a shared memory is limited, when multiple programs concurrently access a shared memory database, the method of this embodiment can more effectively dynamically manage the size of the memory space of the table objects in the database, improve the utilization rate of the shared memory, and enhance the performance of the computer.

The beneficial effects of this embodiment compared with the prior art are:

This embodiment can create a virtual storage space for each table object in the database. The virtual storage space is preset according to a size of the table object. The physical storage space actually allocated to the table object is dynamically increased and shrunk as data is written or deleted. This solves the problems of the insufficient usage efficiency of the physical storage space and a fragmentation of storage space in the system, and realizes a data storage virtualization management.

This embodiment provides a corresponding virtual address block list for each table object in the database and dynamically manages the shared storage space for each table object. It can dynamically allocate and release the shared storage space for each table object, and uses a mutual mapping of the virtual address space and the physical storage space. The virtual address space and the physical storage space can be managed separately, or they can be managed uniformly according to a mapping relationship.

In this embodiment, the storage space can be allocated and released according to a fixed size of each table object, or storage space can be allocated and released dynamically according to the fixed size of each table object. Since the virtual address space is a continuous list of virtual blocks, multiple physical storage spaces can still form a continuous physical storage space through a mapping relationship after expansion. When accessing data, the database does not need to search across segments. The performance will not be reduced before and after expansion, thereby improving the utilization efficiency of the shared storage space.

At the same time, the present embodiment can also, when multiple programs are connected to the shared storage space data, the shared storage space opened by each program has been completely mapped to the virtual address space of each program and loaded into each client program. Each program accesses the database equivalent to accessing the database within its own program. After the shared storage space of each table object is expanded, each process does not need to remap the shared storage space to the virtual address space of the program, thereby improving the access efficiency of each table object in the database during a expansion period when multiple processes access the database, reducing a complexity of an expansion management of the shared storage space of each table object in the database, and improving the performance of the computer.

In addition, the embodiments of the present application can also merge adjacent free blocks when reclaiming a storage space to reduce the fragmentation of the storage space and improve the performance of the computer.

### Example 2

In a second aspect, as shown in FIG. 5, this embodiment provides a storage space allocation device of a shared storage space database, including:
An initial storage space allocation module, is configured to correspondingly allocate a virtual address block list of a preset length based on an initial storage space requirement of each table object in a database, the virtual address block list includes virtual blocks, each of the virtual blocks corresponds a first preset space;
A corresponding relationship establishing module, is configured to obtain a first corresponding relationship between the table object in the database and each virtual address in the virtual block of the virtual address block list, and to obtain a second corresponding relationship between the virtual block and a physical block in a physical storage space that is pre-allocated, the physical block is corresponding to a second preset space;
An addition/deletion operation monitoring module, is configured to monitor an addition/deletion operation of data in the table object in the virtual block;
A first address acquisition module, is configured to obtain, according to the monitored addition/deletion operation and based on the first corresponding relationship, a first virtual address in a first virtual block corresponding to the first data in the table object, and obtain, based on the second corresponding relationship, the first physical address in the first physical block corresponding to the first virtual address;
A second address acquisition module, is configured to obtain a second physical address in a second physical block for second data generated after the addition/deletion operation, and obtain a second virtual address in a second virtual block corresponding to the second physical address based on a second corresponding relationship;
A storage status updating module, is configured to update a storage status of the second physical block based on a storage status of the second physical address after the addition/deletion operation, and synchronously update the storage status of the second virtual address and the storage status of the second virtual block.

The beneficial effects of this embodiment compared with the prior art are:

This embodiment provides a storage space allocation device for a shared storage space database, provides a corresponding virtual address block list for each table object in the shared storage space database, and dynamically manages the shared storage space for each table object. It can dynamically allocate and release the shared storage space for each table object, and uses the virtual address space and the physical storage space to map to each other. The virtual address space and the physical storage space can be managed separately, or they can be managed uniformly according to the mapping relationship.

This embodiment can allocate and release the storage space according to a fixed size of each table object, and can also allocate and release storage space dynamically according to the fixed size of each table object. Since the virtual address space is a continuous list of virtual blocks, multiple physical storage spaces can still form a continuous physical storage space through a mapping relationship after an expansion. When accessing data, the database does not need to search across segments. The performance is not reduced before and after the expansion, thereby improving the utilization efficiency of the shared storage space.

At the same time, in this embodiment, when multiple programs are connected to the data of the shared storage space, the shared storage space opened by each program has been completely mapped to the virtual address space of each program and loaded into each client program. Each program accesses the database, which is equivalent to accessing the database within its own program. After the shared storage space of each table object is expanded, each process does not need to remap the shared storage space to the virtual address space of the program, thereby improving the access efficiency of each table object in the database during the expansion period when multiple processes access the database, reducing the complexity of the expansion management of the shared storage space of each table object in the database, and improving the performance of the computer.

In addition, the embodiments of the present application can also merge adjacent free blocks when reclaiming the storage space to reduce the fragmentation of the storage space and improve the performance of the computer.

It should be noted that the information interaction, execution process, etc. between the above-mentioned devices/units are based on the same concept as the method embodiment of the present application. Their specific functions and technical effects can be found in the method embodiment section and will not be repeated here.

The technical personnel in the related field can clearly understand that, for the convenience and simplicity of description, only the division of the above-mentioned functional units and modules is illustrated, in practical applications, the above-mentioned function distribution can be completed by different functional units and modules as needed, that is, the internal structure of the device is divided into different functional units or modules, to complete all or part of the functions described above. Each functional unit and module in the embodiment can be integrated in a processing unit, or each unit can exist physically alone, or two or more units can be integrated in one unit, and the above-mentioned integrated unit can be implemented in the form of hardware or in the form of software functional units. In addition, the specific names of each functional unit and module are also only for the convenience of distinguishing from each other, and are not used to limit the scope of protection of the present application. The specific working process of the unit and module in the above-mentioned system can refer to the corresponding process in the aforementioned method embodiment, and will not be repeated here.

### Example 3

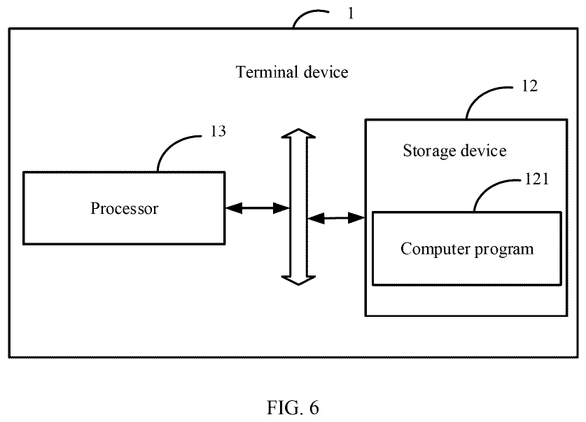

In a third aspect, as shown in FIG. 6, an embodiment of the present application provides a terminal device 1, including:

A storage device 12, at least one processor 13, and a computer program 121 stored in the storage device 12 and executable by the at least one processor 13, when the at least one processor 13 executes the computer program, the method for allocating the storage space of a shared storage space database as described in any one of the first aspects above is implemented.

### Example 4

In a fourth aspect, an embodiment of the present application provides a computer-readable storage medium, including:

The computer-readable storage medium stores a computer program, and when the computer program is executed by the processor, it implements the method for allocating the storage space of the shared storage space database as described in any one of the contents of the first aspect above.

### Example 5

In a fifth aspect, an embodiment of the present application provides a computer program product. When the computer program product is running on a terminal device, the terminal device executes the method for allocating the storage space of the shared storage space database as described in any one of the first aspects above.

It can be understood that the beneficial effects of the second to fifth aspects mentioned above can be found in the relevant description of the first aspect mentioned above, and will not be repeated here.

The method for allocating the storage space of the shared storage space database provided in an embodiment of the present application can be applied to terminal devices such as mobile phones, tablet computers, wearable devices, vehicle-mounted devices, augmented reality (AR)/virtual reality (VR) devices, laptop computers, ultra-mobile personal computers (UMPC), netbooks, personal digital assistants (PDA), etc. The embodiment of the present application does not impose any restrictions on the specific type of the terminal device.

If the integrated unit is implemented in the form of a software functional unit and sold or used as an independent product, it can be stored in a computer readable storage medium. Based on such understanding, the application implements all or part of the flow in the above-mentioned embodiment method, and can be completed by instructing the relevant hardware through a computer program, and the computer program can be stored in a computer readable storage medium, and the computer program can realize the steps of the above-mentioned various method embodiments when being executed by a processor. Wherein, the computer program includes a computer program code, and the computer program code can be a source code form, an object code form, an executable file or some intermediate forms, etc.

The computer-readable medium may at least include: any entity or device capable of carrying the computer program code to the camera/terminal device, a recording medium, a computer memory, a read-only memory (ROM), a random access memory (RAM), an electric carrier signal, a telecommunication signal, and a software distribution medium. For example, a USB flash drive, a mobile hard disk, a magnetic disk, or an optical disk. In some jurisdictions, according to legislation and patent practice, the computer-readable medium cannot be an electric carrier signal or a telecommunication signal.

In the above embodiments, the description of each embodiment has its own emphasis. For the parts that are not described or recorded in detail in a certain embodiment, please refer to the relevant descriptions of other embodiments.

Those of ordinary skill in the art will appreciate that the units and algorithmic steps of each example described in conjunction with the embodiments disclosed herein can be implemented with electronic hardware or a combination of computer software and electronic hardware. Whether these functions are performed in hardware or software mode depends on the specific application and design constraints of the technical solution. Professional and technical personnel can use different methods to implement the described functions for each specific application, but this implementation should not be considered to exceed the scope of the application.

In the embodiment provided by the present application, it should be understood that the disclosed device/network equipment and method can be realized by other means. For example, the device/network equipment embodiment described above is only schematic, for example, the division of the module or unit is only a kind of logical function division, and other division modes can be arranged during actual implementation, for example, multiple units or components can be combined or can be integrated into another system, or some features can be ignored, or do not execute. Another point, the coupling or direct coupling or communication connection between each other shown or discussed can be through some interfaces, the indirect coupling or communication connection of the device or unit can be electrical, mechanical or other forms.

The units described as separate components may or may not be physically separated, and the components displayed as units may or may not be physical units, that is, they may be located in one place, or they may be distributed on multiple network units. Some or all of the units may be selected according to actual needs to achieve the purpose of the present embodiment.

The embodiments described above are only used to illustrate the technical solutions of the present application, rather than to limit them. Although the present application has been described in detail with reference to the aforementioned embodiments, a person of ordinary skill in the art should understand that the technical solutions described in the aforementioned embodiments can still be modified, or some of the technical features therein can be replaced by equivalents. Such modifications or replacements do not deviate the essence of the corresponding technical solutions from the spirit and scope of the technical solutions of the embodiments of the present application, and should all be included in the protection scope of the present application.

What is claimed is:

1. A storage space allocation method, comprising:
based on an initial storage space requirement of each table object in a database, correspondingly allocating a first virtual address block list of a preset length for each table object, the first virtual address block list comprising virtual blocks, each of the virtual blocks corresponding a first preset space;
obtaining a first corresponding relationship between the table object in the database and each virtual address in the virtual block of the first virtual address block list, and obtaining a second corresponding relationship between the virtual block and a physical block in a physical storage space that is pre-allocated, the physical block corresponding a second preset space;
monitoring an addition/deletion operation of data in the table object in the virtual block;
according to the monitored addition/deletion operation, obtaining a first virtual address in a first virtual block corresponding to first data in the table object based on the first corresponding relationship, and obtaining a first physical address in a first physical block corresponding to the first virtual address based on the second corresponding relationship;
obtaining a second physical address in a second physical block for second data, the second data being generated by performing the addition/deletion operation on the first data, and obtaining a second virtual address in a second virtual block corresponding to the second physical address based on the second corresponding relationship;
updating a storage status of the second physical block based on a storage status of the second physical address after the addition/deletion operation, and synchronously updating a storage status of the second virtual address and a storage status of the second virtual block.

2. The storage space allocation method as described in claim 1, wherein “obtaining a second physical address in a second physical block for second data after the addition/deletion operation, and obtaining a second virtual address in a second virtual block corresponding to the second physical address based on the second corresponding relationship” comprises:
performing an operation of adding data on the table object and obtaining the second data;
in response that a free physical storage space in the first physical block is smaller than a space for the added data in the second data, writing the added data in the second data into at least one free physical block in the physical storage space in sequence, and obtaining the second physical address in the second physical block that has completed writing;
based on the second corresponding relationship, obtaining the second virtual address in the second virtual block corresponding to the second physical address that has completed writing; and
adding at least one second virtual block to the first virtual block in sequence and generating a second virtual address block list with consecutive numbers.

3. The storage space allocation method as described in claim 1, wherein “obtaining a second physical address in a second physical block for second data after the addition/deletion operation, and obtaining a second virtual address in a second virtual block corresponding to the second physical address based on the second corresponding relationship” further comprises:
performing an operation of deleting data on the table object and obtaining the second data;
in response that the physical storage space in the first physical block is larger than a space for the second data, releasing at least one occupied physical block in the physical storage space in sequence based on a space of the second data after the data is deleted, and obtaining the second physical address in the second physical block that has completed deleting;
based on the second corresponding relationship, obtaining the second virtual address in the second virtual block corresponding to the second physical address that has completed deleting;
starting from the first virtual block, releasing at least one second virtual block sequentially forward and generating a second virtual address list with consecutive numbers.

4. The storage space allocation method as described in claim 1, wherein “updating a storage status of the second physical block based on a storage status of the second physical address after the addition/deletion operation, and synchronously updating a storage status of the second virtual address and a storage status of the second virtual block” comprises:
after the operation of adding data in the table object, updating the storage status of the second physical address from an idle status to an occupied status, and updating the storage status of the second physical block where the second physical address is located from the idle status to the occupied status;
synchronously updating the storage status of the second virtual address corresponding to the second physical address from the idle status to the occupied status, and synchronously updating the storage status of the second virtual block where the second virtual address is located from the idle status to the occupied status.

5. The storage space allocation method according to claim 1, wherein “updating a storage status of the second physical block based on a storage status of the second physical address after the addition/deletion operation, and synchronously updating a storage status of the second virtual address and a storage status of the second virtual block” comprises:
after the operation of deleting data is performed on the table object, continuing to set the storage status of the second physical address to the occupied status, and continuing to set the storage status of the second physical block where the second physical address is located to the occupied status;
updating the storage status of a third physical address from the occupied status to the idle status, and updating the storage status of the first physical block where the first physical address is located from the occupied status to the idle status, the third physical address being a physical address segment between the first physical address and the second physical address;
continuing to set the storage status of the second virtual address corresponding to the second physical address to the occupied status, and continuing to set the storage status of the second virtual block corresponding to the second physical block where the second physical address is located to the occupied status;
synchronously updating the storage status of the third virtual address corresponding to the third physical address from the occupied status to the idle status, and synchronously updating the storage status of the first virtual block where the first virtual address is located from the occupied status to the idle status, the third virtual address being a virtual address segment between the first virtual address and the second virtual address.

6. The storage space allocation method as claimed in claim 1, after “obtaining a first corresponding relationship between the table object in the database and each virtual address in the virtual block of the first virtual address block list, and obtaining a second corresponding relationship between the virtual block and a physical block in a physical storage space that is pre-allocated”, further comprising:
concurrently monitoring the addition/deletion operations of data in each of the table objects in the virtual block;
according to the concurrently monitored addition/deletion operations, concurrently obtaining a first virtual address in the first virtual block corresponding to the first data in each of the table objects based on the first corresponding relationship, and concurrently obtaining a first physical address in the first physical block corresponding to each of the first virtual addresses based on the second corresponding relationship;
concurrently obtaining a second physical address in the second physical block for the second data after the addition/deletion operations, and concurrently obtaining a second virtual address in the second virtual block corresponding to the second physical address based on the second corresponding relationship;
based on the storage status of the second physical address after the concurrent addition/deletion operations, updating the storage status of the second physical block, and concurrently synchronously updating the storage status of the second virtual address and the storage status of the second virtual block.

7. The storage space allocation method as claimed in claim 1, wherein the first preset space is equal to the second preset space, and both are set to be less than or equal to 4 MB; the preset length is set to be less than or equal to 2147483648.

8. A terminal device, comprising:
at least one processor; and
a storage device, the storage device storing a computer program, which when executed by the at least one processor, cause the at least one processor to:
based on an initial storage space requirement of each table object in a database, correspondingly allocate a first virtual address block list of a preset length for each table object, the first virtual address block list comprising virtual blocks, each of the virtual blocks corresponding a first preset space;
obtain a first corresponding relationship between the table object in the database and each virtual address in the virtual block of the first virtual address block list, and obtain a second corresponding relationship between the virtual block and a physical block in a physical storage space that is pre-allocated, the physical block corresponding a second preset space;
monitor an addition/deletion operation of data in the table object in the virtual block;
according to the monitored addition/deletion operation, obtain a first virtual address in a first virtual block corresponding to first data in the table object based on the first corresponding relationship, and obtain a first physical address in a first physical block corresponding to the first virtual address based on the second corresponding relationship;
obtain a second physical address in a second physical block for second data after the addition/deletion operation, and obtain a second virtual address in a second virtual block corresponding to the second physical address based on the second corresponding relationship;
update a storage status of the second physical block based on a storage status of the second physical address after the addition/deletion operation, and synchronously update a storage status of the second virtual address and a storage status of the second virtual block.

9. The terminal device as described in claim 8, wherein “obtaining a second physical address in a second physical block for second data after the addition/deletion operation, and obtaining a second virtual address in a second virtual block corresponding to the second physical address based on the second corresponding relationship” comprises:
performing an operation of adding data on the table object and obtaining the second data;
in response that a free physical storage space in the first physical block is smaller than a space for the added data in the second data, writing the added data in the second data into at least one free physical block in the physical storage space in sequence, and obtaining the second physical address in the second physical block that has completed writing;
based on the second corresponding relationship, obtaining the second virtual address in the second virtual block corresponding to the second physical address that has completed writing; and
adding at least one second virtual block to the first virtual block in sequence and generating a second virtual address block list with consecutive numbers.

10. The terminal device as described in claim 8, wherein “obtaining a second physical address in a second physical block for second data after the addition/deletion operation, and obtaining a second virtual address in a second virtual block corresponding to the second physical address based on the second corresponding relationship” further comprises:
performing an operation of deleting data on the table object and obtaining the second data;
in response that the physical storage space in the first physical block is larger than a space for the second data, releasing at least one occupied physical block in the physical storage space in sequence based on a space of the second data after the data is deleted, and obtaining the second physical address in the second physical block that has completed deleting;
based on the second corresponding relationship, obtaining the second virtual address in the second virtual block corresponding to the second physical address that has completed deleting;
starting from the first virtual block, releasing at least one second virtual block sequentially forward and generating a second virtual address list with consecutive numbers.

11. The terminal device as described in claim 8, wherein “updating a storage status of the second physical block based on a storage status of the second physical address after the addition/deletion operation, and synchronously updating a storage status of the second virtual address and a storage status of the second virtual block” comprises:
after the operation of adding data in the table object, updating the storage status of the second physical address from an idle status to an occupied status, and updating the storage status of the second physical block where the second physical address is located from the idle status to the occupied status;
synchronously updating the storage status of the second virtual address corresponding to the second physical address from the idle status to the occupied status, and synchronously updating the storage status of the second virtual block where the second virtual address is located from the idle status to the occupied status.

12. The terminal device according to claim 8, wherein “updating a storage status of the second physical block based on a storage status of the second physical address after the addition/deletion operation, and synchronously updating a storage status of the second virtual address and a storage status of the second virtual block” comprises:
after the operation of deleting data is performed on the table object, continuing to set the storage status of the second physical address to the occupied status, and continuing to set the storage status of the second physical block where the second physical address is located to the occupied status;
updating the storage status of a third physical address from the occupied status to the idle status, and updating the storage status of the first physical block where the first physical address is located from the occupied status to the idle status, the third physical address being a physical address segment between the first physical address and the second physical address;
continuing to set the storage status of the second virtual address corresponding to the second physical address to the occupied status, and continuing to set the storage status of the second virtual block corresponding to the second physical block where the second physical address is located to the occupied status;
synchronously updating the storage status of the third virtual address corresponding to the third physical address from the occupied status to the idle status, and synchronously updating the storage status of the first virtual block where the first virtual address is located from the occupied status to the idle status, the third virtual address being a virtual address segment between the first virtual address and the second virtual address.

13. The terminal device as claimed in claim 8, after “obtaining a first corresponding relationship based on a first preset corresponding relationship between the table object in the database and each virtual address in the virtual block of the first virtual address block list, and obtaining a second corresponding relationship based on a second preset corresponding relationship between the virtual block and a physical block in a physical storage space that is pre-allocated”, further comprising:
concurrently monitoring the addition/deletion operations of data in each of the table objects in the virtual block;
according to the concurrently monitored addition/deletion operations, concurrently obtaining a first virtual address in the first virtual block corresponding to the first data in each of the table objects based on the first corresponding relationship, and concurrently obtaining a first physical address in the first physical block corresponding to each of the first virtual addresses based on the second corresponding relationship;
concurrently obtaining a second physical address in the second physical block for the second data after the addition/deletion operations, and concurrently obtaining a second virtual address in the second virtual block corresponding to the second physical address based on the second corresponding relationship;
based on the storage status of the second physical address after the concurrent addition/deletion operations, updating the storage status of the second physical block, and concurrently synchronously updating the storage status of the second virtual address and the storage status of the second virtual block.

14. The terminal device as claimed in claim 8, wherein the first preset space is equal to the second preset space, and both are set to be less than or equal to 4 MB; the preset length is set to be less than or equal to 2147483648.

15. A non-transitory storage medium having a computer program stored thereon, when the computer program is executed by a processor of a terminal device, the processor is caused to perform a storage space allocation method, wherein the method comprises:
based on an initial storage space requirement of each table object in a database, correspondingly allocating a first virtual address block list of a preset length for each table object, the first virtual address block list comprising virtual blocks, each of the virtual blocks corresponding a first preset space;
obtaining a first corresponding relationship between the table object in the database and each virtual address in the virtual block of the first virtual address block list, and obtaining a second corresponding relationship between the virtual block and a physical block in a physical storage space that is pre-allocated, the physical block corresponding a second preset space;
monitoring an addition/deletion operation of data in the table object in the virtual block;
according to the monitored addition/deletion operation, obtaining a first virtual address in a first virtual block corresponding to first data in the table object based on the first corresponding relationship, and obtaining a first physical address in a first physical block corresponding to the first virtual address based on the second corresponding relationship;
obtaining a second physical address in a second physical block for second data after the addition/deletion operation, and obtaining a second virtual address in a second virtual block corresponding to the second physical address based on the second corresponding relationship;
updating a storage status of the second physical block based on a storage status of the second physical address after the addition/deletion operation, and synchronously updating a storage status of the second virtual address and a storage status of the second virtual block.

16. The non-transitory storage medium as described in claim 15, wherein “obtaining a second physical address in a second physical block for second data after the addition/deletion operation, and obtaining a second virtual address in a second virtual block corresponding to the second physical address based on the second corresponding relationship” comprises:
performing an operation of adding data on the table object and obtaining the second data;
in response that a free physical storage space in the first physical block is smaller than a space for the added data in the second data, writing the added data in the second data into at least one free physical block in the physical storage space in sequence, and obtaining the second physical address in the second physical block that has completed writing;
based on the second corresponding relationship, obtaining the second virtual address in the second virtual block corresponding to the second physical address that has completed writing; and
adding at least one second virtual block to the first virtual block in sequence and generating a second virtual address block list with consecutive numbers.

17. The non-transitory storage medium as described in claim 15, wherein “obtaining a second physical address in a second physical block for second data after the addition/deletion operation, and obtaining a second virtual address in a second virtual block corresponding to the second physical address based on the second corresponding relationship” further comprises:
performing an operation of deleting data on the table object and obtaining the second data;
in response that the physical storage space in the first physical block is larger than a space for the second data, releasing at least one occupied physical block in the physical storage space in sequence based on a space of the second data after the data is deleted, and obtaining the second physical address in the second physical block that has completed deleting;
based on the second corresponding relationship, obtaining the second virtual address in the second virtual block corresponding to the second physical address that has completed deleting;
starting from the first virtual block, releasing at least one second virtual block sequentially forward and generating a second virtual address list with consecutive numbers.

18. The non-transitory storage medium as described in claim 15, wherein “updating a storage status of the second physical block based on a storage status of the second physical address after the addition/deletion operation, and synchronously updating a storage status of the second virtual address and a storage status of the second virtual block” comprises:
after the operation of adding data in the table object, updating the storage status of the second physical address from an idle status to an occupied status, and updating the storage status of the second physical block where the second physical address is located from the idle status to the occupied status;
synchronously updating the storage status of the second virtual address corresponding to the second physical address from the idle status to the occupied status, and synchronously updating the storage status of the second virtual block where the second virtual address is located from the idle status to the occupied status.

19. The non-transitory storage medium according to claim 15, wherein “updating a storage status of the second physical block based on a storage status of the second physical address after the addition/deletion operation, and synchronously updating a storage status of the second virtual address and a storage status of the second virtual block” comprises:
after the operation of deleting data is performed on the table object, continuing to set the storage status of the second physical address to the occupied status, and continuing to set the storage status of the second physical block where the second physical address is located to the occupied status;
updating the storage status of a third physical address from the occupied status to the idle status, and updating the storage status of the first physical block where the first physical address is located from the occupied status to the idle status, the third physical address being a physical address segment between the first physical address and the second physical address;
continuing to set the storage status of the second virtual address corresponding to the second physical address to the occupied status, and continuing to set the storage status of the second virtual block corresponding to the second physical block where the second physical address is located to the occupied status;
synchronously updating the storage status of the third virtual address corresponding to the third physical address from the occupied status to the idle status, and synchronously updating the storage status of the first virtual block where the first virtual address is located from the occupied status to the idle status, the third virtual address being a virtual address segment between the first virtual address and the second virtual address.

20. The non-transitory storage medium according to claim 15, after “obtaining a first corresponding relationship based on a first preset corresponding relationship between the table object in the database and each virtual address in the virtual block of the first virtual address block list, and obtaining a second corresponding relationship based on a second preset corresponding relationship between the virtual block and a physical block in a physical storage space that is pre-allocated”, further comprising:
concurrently monitoring the addition/deletion operations of data in each of the table objects in the virtual block;
according to the concurrently monitored addition/deletion operations, concurrently obtaining a first virtual address in the first virtual block corresponding to the first data in each of the table objects based on the first corresponding relationship, and concurrently obtaining a first physical address in the first physical block corresponding to each of the first virtual addresses based on the second corresponding relationship;
concurrently obtaining a second physical address in the second physical block for the second data after the addition/deletion operations, and concurrently obtaining a second virtual address in the second virtual block corresponding to the second physical address based on the second corresponding relationship;
based on the storage status of the second physical address after the concurrent addition/deletion operations, updating the storage status of the second physical block, and concurrently synchronously updating the storage status of the second virtual address and the storage status of the second virtual block.
